(19) United States
(12) Patent Application Publication
(10) Pub. No.: US 2012/0190388 A1
(43) Pub. Date: Jul. 26, 2012

(54) METHODS AND APPARATUS FOR MODIFYING A MULTIMEDIA OBJECT WITHIN AN INSTANT MESSAGING SESSION AT A MOBILE COMMUNICATION DEVICE

(75) Inventors: Mark Castleman, Austin, TX (US); James Hays, Windsor, CO (US); Cory Yoon Sung Kim, Cedar Park, TX (US); Jeremy Hale Schneider, New York, NY (US)

(73) Assignee: SWAKKER LLC, New York, NY (US)

(21) Appl. No.: 13/219,247

(22) Filed: Aug. 26, 2011

Related U.S. Application Data
(63) Continuation of application No. 12/986,988, filed on Jan. 7, 2011, now abandoned.
(60) Provisional application No. 61/293,054, filed on Jan. 7, 2010.

(51) Int. Cl. H04W 4/12

(52) U.S. Cl. 455/466

(57) ABSTRACT

In one embodiment, a processor-readable medium stores code representing instructions that when executed cause a processor to receive a first signal at a mobile device, the first signal including a mobile instant message having inline image data, the inline image data defining an image. The processor-readable medium stores code further representing instructions that when executed cause the processor to receive an edit command associated with the image and send a second signal, the second signal including a mobile instant message having a directive based at least in part on the edit command.

### CROSS-REFERENCE TO RELATED APPLICATION

This application is a continuation application of U.S. patent application Ser. No. 12/986,988 entitled “Methods And Apparatus For Modifying A Multimedia Object Within An Instant Messaging Session At A Mobile Communication Device” filed Jan. 7, 2011, which claims priority to U.S. Provisional Patent Application Ser. No. 61/293,054, entitled “Methods and Apparatus for Modifying a Multimedia Object Within an Instant Messaging Session at a Mobile Communication Device,” filed Jan. 7, 2010, the disclosures of which are hereby incorporated by reference in their entirety.

### BACKGROUND

Embodiments described herein relate generally to text-based communication using computerized devices, and more particularly to methods and apparatus for multimedia- and text-based instant messaging on a mobile device.

Individuals use a variety of software technologies to engage in text-based communication via their personal computers. Among these are electronic mail and instant messaging, each of which typically allows users to exchange text and multimedia such as graphics, images, audio clips and video. As mobile computing and telephony technology have evolved in recent years, these communication technologies have been implemented on portable devices such as smartphones, PDAs and tablet computing devices.

Many instant messaging solutions for mobile devices allow users to exchange text-based instant messages composed using the device's physical or on-screen keyboard. Such solutions, however, are often limited in functionality and lack the ability to transmit multimedia within mobile instant messages. These solutions also fail to allow a user to edit a multimedia object received from a chat partner and send the edited object back to one or more chat partners. Thus, a need exists for methods and apparatus for sending, receiving and modifying a multimedia object within an instant messaging session at a mobile communication device.

### SUMMARY

In one embodiment, a processor-readable medium stores code representing instructions that when executed cause a processor to receive a first signal at a mobile device, the first signal including a mobile instant message having inline image data, the inline image data defining an image. The processor-readable medium stores code further representing instructions that when executed cause the processor to receive an edit command associated with the image and send a second signal, the second signal including a mobile instant message having a directive based at least in part on the edit command.

### BRIEF DESCRIPTION OF THE DRAWINGS

FIG. 1 is a schematic block diagram of a first mobile device and a second mobile device, each operatively coupled to a server device and to one another via a network, according to an embodiment.

FIG. 2 is a schematic block diagram of a mobile device, according to another embodiment.

FIG. 3 is a schematic block diagram of a mobile instant-messaging module, according to another embodiment.

FIG. 4 is a top view of a mobile device displaying a multimedia-enabled instant messaging window, according to another embodiment.

FIG. 5 is a top view of a mobile device displaying an image edit window currently being controlled by a user of the mobile device, according to another embodiment.

FIG. 6 is a flowchart of a method of receiving, at a mobile device, a first instant message that includes an image, editing the image, and sending a second instant message including the edited image, according to another embodiment.

### DETAILED DESCRIPTION

In some embodiments, a first mobile device can be operatively coupled to a second mobile device via one or more wireless transponders, a network and/or a server device. The first mobile device and/or the second mobile device can each be, for example, a cellular telephone (e.g., a smartphone), a personal digital assistant (PDA) or other mobile computing device. The wireless transponders and/or the network can each be included in, for example, a mobile communication network, such as a cellular telephone network and/or local area network operatively coupled to the Internet.

In some embodiments, each of the first mobile device and the second mobile device can include a memory, a processor and one or more modules. For example, the first mobile device can include an input/output module, an input device and/or an output device. The input/output module can be configured to exchange information, such as data packets, with the server device and/or the second mobile device. The input device can be, for example, a physical keyboard, an on-screen keyboard, a touchscreen, microphone, or other input device. The output device can be, for example, a visual display, such as a screen, an audio speaker, etc.

The instant-messaging module can be any combination of hardware and/or software (executing in hardware) configured to define one or more text-based and/or multimedia-based instant messages. For example, the instant-messaging module can be configured to (1) define an instant message that includes an image, (2) render a received instant message that includes text and/or an image, (3) receive image edit commands from a user, (4) define an edited image, (5) define one or more edited image commands (sometimes referred to herein as a type of “directive(s)”) based on the received edit commands and/or, (6) render an edited image based at least in part on one or more edited image commands/directives.

In some embodiments, the instant-messaging module can define one or more such directives within Extensible Markup Language (XML) tags, such as Extensible Messaging and Presence Protocol (XMPP) tags. For example, the instant-messaging module can define one or more <payload> tags, each <payload> tag including information associated with a portion of an image or an edited image, such as one or more pixels or lines of the image. In some embodiments, the one or more XML and/or XMPP tags can include inline information encoded in base64 format. The encoded information can include, for example, image and/or image edit information. In this manner, the first mobile device can send and/or receive image and/or image edit information inline and with relatively low latency, using relatively little bandwidth and/or processing overhead.

In some embodiments, the server device can be configured to receive one or more instant messages from the first mobile device and/or the second mobile device. For example, the server device can receive a first multimedia instant message from the first mobile device. The first multimedia instant message can include, for example, an image, and include one or more XMPP tags including inline information encoded in base64 format. In some embodiments, the server device can store a copy of the received first multimedia instant message at a memory and/or forward the message on to the second mobile device (via the network mentioned above). In this manner, the server device can maintain a record of an instant message session between the first mobile device and the second mobile device, allowing the server device to (1) undo and/or redo image edits made by one of the mobile device, and/or (2) play back to a requesting mobile device, at least a portion of the instant message session.

Upon receipt of the first mobile instant message, the second mobile device can be configured to render the contents of the first mobile instant message at a display, such as a screen. In some embodiments, the second mobile device can do so by decoding inline information encoded in base64 format, such as text data, image data and/or image edit data. The second mobile device can also optionally present an image edit module to a user of the second mobile device, and receive one or more image edit commands from the user. In response to the one or more image edit commands, the second mobile device can render an edited version of the image and/or define one or more directives describing the image edit commands. Having defined the one or more directives, the second mobile device can optionally send, to the first mobile device, via the network and the server device, a second multimedia instant message including the edited image and/or the defined directives. Upon receipt of the second multimedia instant message, the first mobile device can render the edited image by either rendering the received image file or applying the received directives to the original image file (as appropriate).

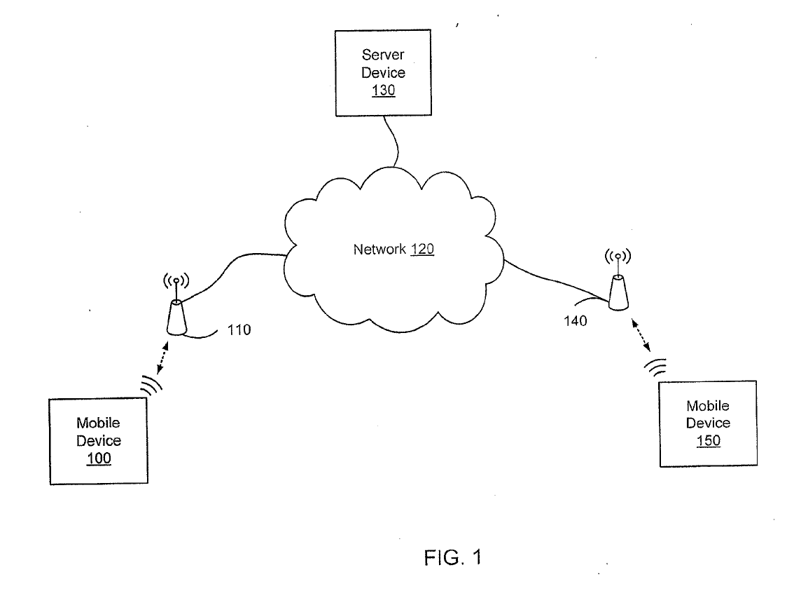

FIG. 1 is a schematic block diagram of a first mobile device and a second mobile device, each operatively coupled to a server device and to one another via a network, according to an embodiment. More specifically, FIG. 1 illustrates a first mobile device 100 operatively coupled to a server device 130 and to a second mobile device 150 via a wireless base station 110 and a network 120. FIG. 1 further illustrates a second mobile device 150 operatively coupled to the server device 130 and to the first mobile device 100 via a wireless base station 140 and the network 120. The mobile device 100 and the mobile device 150 exchange information via the wireless base stations 110 and 140, respectively, the network 120 and the server device 130.

The mobile devices 100 and 150 can each be, for example, any mobile computing and/or communication device, such as a cellular telephone, smartphone, pager, personal digital assistant (PDA), tablet computing device, or portable computer. In some embodiments, the mobile devices 100 and 150 can include hardware and/or software configured to allow user input, such as a keyboard, touchscreen, voice command system employing a microphone, camera, joystick, or other input device (not shown in FIG. 1). The mobile devices 100 and 150 can each include one or more antennae (not shown in FIG. 1) for transmitting and receiving communication signals to and from wireless base stations 110 and 140, respectively. The mobile devices 100 and 150 can also include one or more hardware and/or software modules configured to exchange information with another computing device (not shown in FIG. 1). For example, the mobile devices 100 and 150 can be smartphones that store and can execute one or more smartphone applications or “apps”. In some embodiments, the mobile devices 100 and 150 can each store and execute a mobile communication software application, such as an instant messaging application (not shown in FIG. 1). The instant messaging application stored and executed at the mobile device 100 can be the same or a different instant messaging application from the instant messaging application stored and executed at the mobile device 150.

The wireless base stations 110 and 140 can each be, for example, any wireless base station device, such as a cellular network tower or base station, wireless network router or switch, or other combination of hardware and/or software configured to transmit information to and from a mobile device via a network. The wireless base stations 110 and 140 can transmit information associated with a mobile instant messaging application to and from the mobile devices 100 and 150. In some embodiments, one or both of the wireless base stations 110 and 140 can be associated with, owned and/or operated by a commercial cellular telephone and/or data carrier.

The network 120 can be any computer or information network capable of marshalling and transmitting data between two or more hardware devices. For example, the network 120 can be a local area network (LAN), a wide area network (WAN) or the Internet. In some embodiments, the network 120 can be comprised of one or more wired and/or wirelessly connected hardware devices.

Server device 130 can be any hardware device (e.g., a processor executing software or firmware/ASIC) configured to administer one or more instant messaging sessions between various mobile devices (such as the mobile devices 100 and 150). As shown in FIG. 1, the server device 130 can be operatively coupled to the mobile devices 100 and 150 via the network 120 and the wireless base stations 110 and 140, respectively. In some embodiments, the server device 130 can be coupled to the network 120 via a wired and/or wireless connection, such as a wired and/or wireless LAN connection. In some embodiments, the server device 130 can optionally store, in a memory (e.g., a database), information associated with one or more such instant message sessions. For example, the server device 130 can store instant message session information such as instant message session participant identifiers, instant message contents/history, instant message timestamps, instant message multimedia assets, and the like. A multimedia object or asset can be an object comprised of data related to one or more types of media such as text data, graphic data, image data, audio data, video data, animation data, etc.

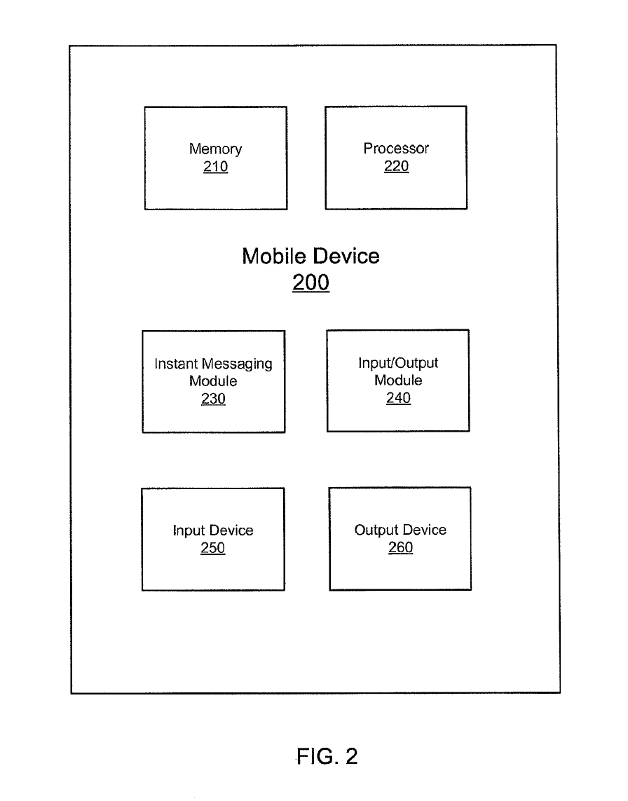

FIG. 2 is a schematic block diagram of a mobile device, according to another embodiment. More specifically, FIG. 2 illustrates a mobile device 200 that includes a memory 210, a processor 220, an instant-messaging module 230, an input/output (I/O) module 240, an input device 250 and an output device 260. The instant-messaging module 230 can receive signals from the input device 250 and send signals to the output device 260. The I/O module 240 can send signals to and receive signals from the instant-messaging module 230.

The mobile device 200 can be, for example, any mobile computing and/or communication device, such as a cellular telephone, smartphone, pager, personal digital assistant (PDA), tablet computing device or portable computer. In some embodiments, the mobile device 200 can be configured to communicate via one or more information exchange protocols such as Global System for Mobile (GSM), GSM/General Packet Radio Service (GPRS), GSM Enhanced Data Rates for GSM Evolution (EDGE), Code Division Multiple Access (CDMA), CDMA2000, WCDMA (Wideband CDMA), IEEE 802.11x, 802.16x (“WiMax”), Long Term Evolution (LTE), and/or the like. The mobile device 200 can enable device-to-device communication via one or more software-based communication clients (executing in hardware) such as the instant-messaging module 230. In some embodiments, the mobile device 200 can include a combination of hardware and/or software, such as the I/O module 240, configured to transfer raw and/or packaged information to and/or from the mobile device 200. The mobile device 200 can also include hardware and/or software configured to allow user input, such as a keyboard, voice command system (employing a microphone), camera, joystick, or other input device such as the input device 250. In some embodiments, the mobile device 200 can include an output device for display of information to a user, such as a touchscreen display or other output device, such as the output device 260.

The memory 210 can be any suitable computer memory. For example, the memory can be random-access memory (RAM), read-only memory (ROM), flash memory, erasable programmable read-only memory (EPROM), electrically erasable programmable read-only memory (EEPROM), and/or other suitable memory. In some embodiments, the memory 210 can be configured to store code representing processor instructions for execution by the processor 220 and/or store data received from the communication module 230.

The processor 220 can be any suitable processor capable of executing computer instructions. In some embodiments, the processor 220 can be a microcontroller, a field-programmable gate array (FPGA), an application specific integrated circuit (ASIC), and/or any other suitable processor.

The instant-messaging module 230 can be a hardware-based and/or software- based module (executing in hardware) configured to provide instant message and/or chat communication functionality to a user of the mobile device 200. For example, in some embodiments, the instant-messaging module 230 can be a mobile device application or “app”, such as an application configured to execute on an Apple iPhone, Google Android, RIM BlackBerry, Palm Pre or other application-capable mobile device.

In some embodiments, the instant-messaging module 230 can provide a user interface that allows a user to exchange instant (or “chat”) messages with another computerized device, such as a mobile computing device, portable computer or desktop computer. In some embodiments, the instant-messaging module 230 can provide functionality that allows a user to send or receive one or more multimedia assets within an instant messaging session. For example, in some embodiments, the instant-messaging module 230 can provide functionality that allows a user to send and/or receive an image, a graphic, an icon, an audio clip, a video clip, or other multimedia object.

In some embodiments, the instant-messaging module 230 can provide functionality that allows a user to edit a multimedia object, such as a multimedia object stored on the mobile device 200, or a multimedia object received or obtained from an external source. For example, in some embodiments, the instant-messaging module 230 can provide functionality that allows a user of the mobile device 200 to edit an image captured by a camera coupled to the mobile device 200. In some embodiments, the instant-messaging module 230 can provide functionality allowing a user to edit an image stored on removable media such as a memory card, an image downloaded from a network such as the Internet (e.g., received during an instant message chat session), an image received via an e-mail message, etc. In some embodiments, the instant-messaging module 230 can provide functionality allowing a user to send, to another computerized device, an instant message including the edited multimedia object and/or one or more editing commands or “directives” configured to allow a receiving device and/or module to perform the indicated edits and display the edited multimedia object.

The I/O module 240 can be any suitable combination of hardware and/or software configured to transfer data packets and/or frames to and from the mobile device 200. For example, in some embodiments, the I/O module 240 can include a software layer or application programming interface (API) that allows other modules of the mobile device 200, such as applications, to exchange information with other computerized devices. In some embodiments, the data transfer module can include one or more hardware components, such as cellular and/or networking cards, antennae and the like.

The input device 250 can be any suitable input device. For example, in some embodiments, the input device 250 can be a keyboard, such as a physical, tactile keyboard or an on-screen keyboard. In some embodiments, the input device 250 can be a microphone configured to receive voice instructions, a pointing device such as a mouse, a stylus, an electronic drawing tablet, a touchscreen and/or other input device physically or operatively coupled to the mobile device 200 and capable of receiving input from a user.

The output device 260 can be any suitable electronic display. For example, output device 260 can be a liquid crystal display (LCD), a series of light-emitting diodes (LEDs), a series of organic light-emitting diodes (OLEDs), an electronic ink (e-ink) display, a projector, or other device employing suitable display technology. In other embodiments, the mobile device 200 does not include a display. In such embodiments, instead of and/or in addition to a display, the mobile detection device 200 can include a speaker, a haptic indicator (e.g., a vibration device) and/or any other output device configured to convey information to a user.

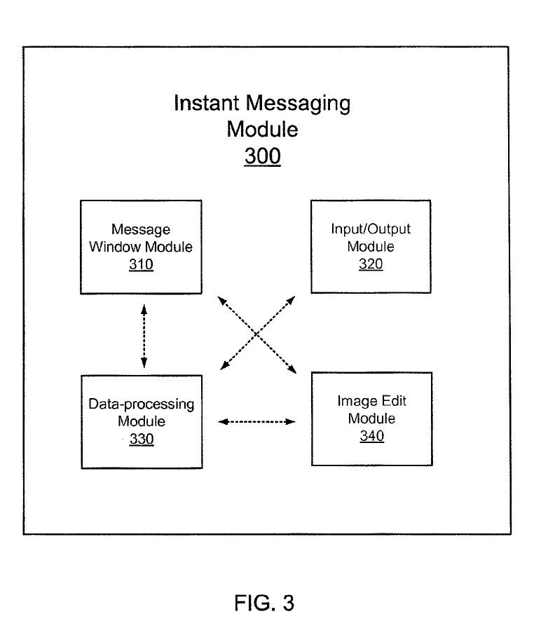

FIG. 3 is a schematic block diagram of a mobile instant-messaging module, according to another embodiment. More specifically, FIG. 3 illustrates a hardware-based and/or software-based (executing in hardware) mobile instant messaging software module 300 that includes a message window module 310, an input/output (“I/O”) module 320, a data-processing module 330 and an image edit module 340. The message window module 310 can send signals to and receive signals from the data-processing module 330 and the image edit module 340. The I/O module 320 can send signals to and receive signals from the data-processing module 330. The data-processing module 330 can send signals to and receive signals from the message window module 310, the I/O module 320 and/or the image edit module 340. The image edit module 340 can send signals to and receive signals from the message window module 310 and the data-processing module 330. In some embodiments, each of the above modules can send signals to and receive signals from each other module included in the instant-messaging module 300.

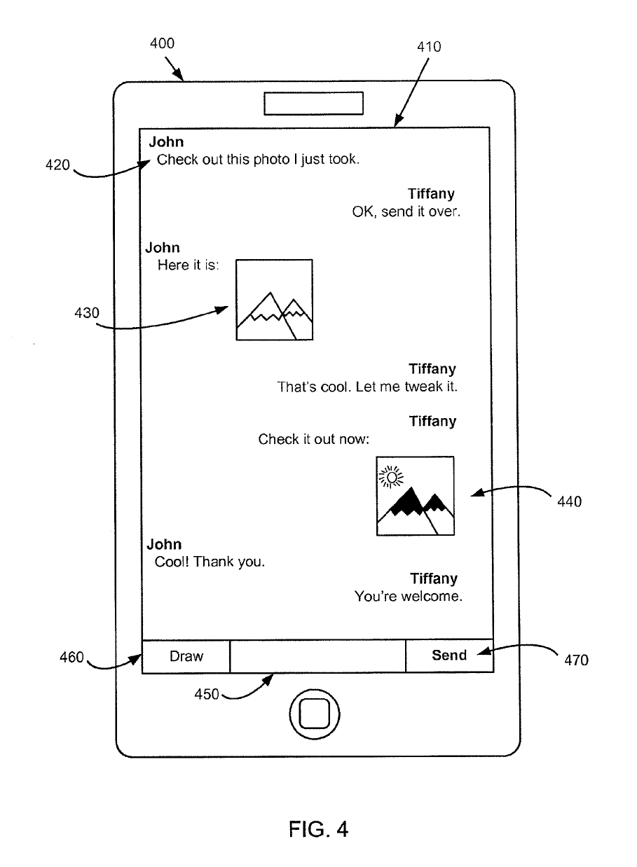

The message window module 310 can be any suitable combination of hardware and/or software configured to present a main user interface for the instant-messaging module 300. In some embodiments, the message window module 310 can include code configured to cause a processor to display a message window via an output device of a mobile computing device (neither shown in FIG. 3). In some embodiments, the message window can include the text of messages exchanged during an instant message session (as described in connection with FIG. 4 below). In some embodiments, the message window can include a message input window that allows a user to compose a new instant message using an input device included in and/or coupled to the mobile communication device (not shown in FIG. 3). In some embodiments, the message window module 310 can include code configured to cause a processor to render one or more multimedia objects, such as images or graphics, within the message window. In some embodiments, the message window module 310 can render one or more such multimedia objects in reduced size or form, so as to satisfy size constraints of the message window.

In some embodiments, the message window module 310 can send one or more signals including input data and/or multimedia object data to the data-processing module 330 for conversion, packaging and/or formatting into an instant message object. In some embodiments, the message window module 310 can receive one or more signals from the data-processing module 330, such as instant message and/or multimedia object data for display in the message window.

In some embodiments, the message window module 310 can send one or more signals to the image edit module 340. For example, in some embodiments the message window module 310 can send a signal configured to cause the image edit module 340 to launch and display a specified image for editing by a user. In some embodiments, the message window module 310 can receive one or more signals from the image edit module 340, such as a signal configured to cause the message window module 310 to re-launch upon completion of an image-editing session.

The I/O module 320 can be a hardware-based and/or software-based module (executing in hardware) configured to receive data from and send data to external sources such as a network, a computerized device, a second mobile computing device, removable media, etc. In some embodiments, the I/O module 320 can include one or more layers of hardware and/or software configured to interact with one or more hardware components of a mobile device for physical transmission of data signals.

In some embodiments, the I/O module 320 can exchange information with an application programming interface (API) stored in a memory of a mobile device (not shown in FIG. 3). In some embodiments, the API can be included as part of an operating system or other software package stored in a memory of the mobile device. For example, the I/O module 320 can exchange information with an API configured to allow for simplified interaction of applications (such as the instant-messaging module 330) with communication hardware such as antennas and network cards.

In some embodiments, the I/O module 320 can receive, from the data-processing module 330, information including one or more communication objects. For example, the I/O module 320 can receive instant message objects, encoded images and/or other multimedia assets for transmission from a mobile device to another computerized device or media. In some embodiments, the I/O module 320 can send information to the data-processing module 330. For example, the I/O module 320 can send instant message objects and/or multimedia objects received from an external source to the data-processing module 330 for further processing.

The data-processing module 330 can be a hardware-based module and/or software-based module (executing in hardware) configured to process instant message and multimedia objects for use by other modules of the instant-messaging module 300 (such as the message window module 310 and/or the image edit module 340). For example, the data-processing module 330 can receive an instant message object and/or multimedia object from the I/O module 320, decode the received instant message object and send text associated with the object to the message window module 310 for display in a message window. The data-processing module 330 can be further configured to decode an image or other multimedia object received from the I/O module 320. For example, the data-processing module 330 can decode a base-64 bitstring included in an instant message object and define a new image file based on the decoded bitstring. In some embodiments, the data-processing module 330 can send the decoded bitstring and/or the new image file to the message window module 310 for display in a message window. In some embodiments, the data-processing module 330 can alternatively send to the message window module 310 a miniaturized version of the new image file for compatibility with screen-size constraints associated with the message window.

In some embodiments, the data-processing module 330 can prepare and/or format a new instant message object for transmission to another computerized device via the I/O module 320. For example, the data-processing module 330 can receive text-based message information from the message window module 310 and, in response, generate a new instant message object that includes the text-based message information. The data-processing module 330 can then send the new instant message object to the I/O module 320 for transmission to a network and/or other device. The generated instant message object can optionally include information associated with a multimedia object, such as an image. If so, the data-processing module 330 can encode an image file into a base-64 bitstring for inclusion in the instant message object. In some embodiments, generated instant message objects can conform to the Extensible Messaging and Presence Protocol (XMPP). Generated instant message objects can also include one or more <message>, <payload> and/or <image> tags associated with the Extensible Markup Language (XML) and/or XMPP standards. In some embodiments, instant message objects generated by the data-processing module 330 can be formatted according to another instant messaging protocol, such as Yahoo! Instant Messenger protocol, MSN Instant Messenger protocol, etc.

In some embodiments, the data-processing module 330 can interact with a file system of a mobile device stored on a memory (not shown in FIG. 3). For example, the data-processing module 330 can save information to and/or retrieve information from a memory of the mobile device. In some embodiments, the data-processing module 330 can receive edited image data from the image edit module 340 and save, to a device memory, a new image file based on the edited image data. Alternatively, the data-processing module 330 can receive image edit data from the image edit module 340 and save, to the device memory, the image edit data along with an original, unedited version of the image. In some embodiments, the data-processing module 330 can respond to a request for an image file from the image edit module 340 by retrieving the image file from a device memory and sending the image file to the image edit module 340.

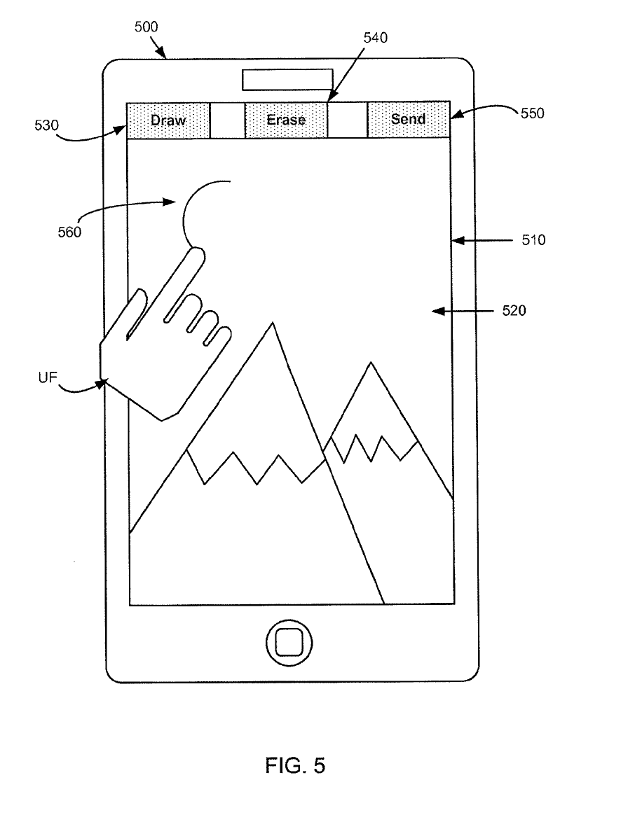

In some embodiments, the image edit module 340 can include code configured to cause a processor to render a multimedia object edit window, such as the image edit window discussed in connection with FIG. 5 below. In some embodiments, the image edit module 340 can include user interface functionality that allows a user to edit an image within the multimedia object edit window by, for example, performing one or more finger “swipes” on a touchscreen (not shown in FIG. 3) included in or coupled to a mobile device. For example, the image edit module 340 can optionally provide functionality that allows a user to draw on, erase portions of, rotate, crop, resize, sharpen, blur, blend, alter the color of, or otherwise manipulate an image. In some embodiments, the image edit module 340 can send image and/or image edit information to the data-processing module 330 for creation of an edited image file and/or a new instant message object that includes the edited image and/or image edit information.

More specifically, in some embodiments, the image edit module 340 can receive the image edit commands described above and define one or more directives based thereon. For example, the image edit module 340 can receive information associated with one or more input actions, such as keyboard key presses and/or finger swipes, pinches and/or taps made on a touchscreen of a mobile device, etc. Based at least in part on input actions, the image edit module 340 can define one or more directives, each directive including information describing the effect of each input action, i.e., the image pixel position, color and/or luminance information resulting from that input action. In some embodiments, the image edit module 340 can define the one or more directives according to the XML and/or XMPP languages/protocols. For example, the image edit module 340 can define, for each directive, a <payload> tag. In this example, the contents of each <payload> tag can include information describing a line segment of the edited image, such as line start and end point coordinates and/or pixel color, luminance (brightness), blending and/or other information. In some embodiments, one or more <payload> tags can include a directive configured to cause a mobile device to render a background image associated with the image.

In some embodiments, image edit module 340 can be launched and displayed on a display of a mobile device in response to a user input instruction received at the message window module 310.

FIG. 4 is a top view of a mobile device displaying a multimedia-enabled instant messaging window, according to another embodiment. More specifically, FIG. 4 illustrates a mobile device 400 that includes a screen 410 displaying a text instant message 420, an image instant message 430, an edited image instant message 440, a message composition box 450, a draw button 460 and a message send button 470.

The mobile device 400 can be any mobile computing and/or communication device, as described in connection with FIGS. 1 and 2 above. The screen 410 can be any suitable output screen for rendering graphics and/or text associated with an instant messaging application. In some embodiments, the screen 410 can be a touchscreen, such as a capacitive touchscreen capable of receiving user input via presses and swipes of one or more human fingers. The screen 410 can be a liquid crystal display (LCD), a series of light-emitting diodes (LEDs), a series of organic light-emitting diodes (OLEDs), an electronic ink (“e-ink”) display, or other device employing suitable display technology.

The screen 410 can be configured to display a user interface associated with an instant messaging application (as shown in FIG. 4). The user interface can include, for example, one or more windows, dialog boxes, images, icons, buttons or other elements.

The text instant message 420 can be any string of alphanumeric text transmitted by a first user of an instant messaging application and displayed inside a message window.

The image instant message 430 can be an instant message containing an image transmitted by a user of an instant messaging application and represented by a small image icon inside a message window. The edited image instant message 440 can be an instant message sent by a second user containing an edited version of an image originally transmitted by the first user of an instant messaging application. In some embodiments, the image instant message 430 and the edited image instant message 440 can each include images structured in a known image file format such as Portable Network Graphics format (PNG), Graphics Interface Format (GIF), Joint Picture Experts Group format (JPEG), Tagged Image File Format (TIFF), Windows bitmap (BMP), RAW, etc.

The message composition box 450 can be any user interface component configured to allow user entry of instant message content such as alphanumeric text or multimedia objects. For example, the message composition box 450 can be a text dialog box.

The draw button 460 can be any user interface component configured to launch an image-editing module when accessed or selected by a user. The send button 470 can be any user interface component configured to send current content entered by a user within the message composition box 450. In some embodiments, at least one of the draw button 460 and the send button 470 can be user interface buttons activated by a user finger and/or stylus press.

As shown in FIG. 4, the mobile device 400 can execute an instant-messaging module similar to the instant-messaging module discussed in connection with FIG. 3 above. In FIG. 4, a first user Tiffany exchanges instant messages with a second user John, with the illustrated mobile device belonging to the first user Tiffany. As shown in FIG. 4, the first user Tiffany receives the image instant message 430, a scaled-down version of which first is rendered within a message window displayed by the screen 410. In some embodiments, a user can transmit an instant message, such as the text instant message 420 or the image instant message 430, by entering text or image information into the message composition box 450, and then pressing or otherwise selecting an area on the screen 410 that defines a user interface element (such as the send button 470).

As also shown in FIG. 4, Tiffany sends to John the edited image instant message 440. In some embodiments, a user can employ an image edit module (such as the image edit module discussed in connection with FIG. 3 above) to enter one or more input commands and thereby define an edited image (such as the edited image instant message 440) based on an original image (such as the image included in the instant message 430). In some embodiments, a user desiring to send an edited image instant message can activate the image edit module by pressing or otherwise selecting an area on the screen 410 that defines a user interface element (such as the draw button 460).

FIG. 5 is a top view of a mobile device displaying an image edit window currently being controlled by a user of the mobile device, according to another embodiment. More specifically, FIG. 5 illustrates a mobile device 500 that includes a screen 510 displaying an image edit region 520, a draw button 530, an erase button 540, a send button 550, and an edited image element 560. FIG. 5 additionally illustrates a user pointer finger UF currently in contact with the screen 510.

The mobile device 500 can be any mobile computing and/or communication device, as described in connection with FIGS. 1 and 2 above. The screen 510 can be any suitable output screen for rendering graphics and/or text associated with an instant messaging application. In some embodiments, the screen 510 can be a touchscreen, such as a capacitive or other touchscreen capable of receiving user input via presses and swipes of one or more user fingers and/or a stylus.

In some embodiments, the screen 510 can be configured to display a user interface (not shown in FIG. 5) associated with an image-editing module of an instant messaging application, such as the image-editing module discussed in connection with FIG. 3 above. The image-editing module can be initialized based on one or more user input signals received by an instant messaging application, such as those discussed in connection with FIG. 4 above. When initialized, the image-editing module can load an image selected by a user into the image edit region 520. In some embodiments, the selected image can be an image captured by a camera included in mobile device 500 (not shown in FIG. 5), an image received from another user via an instant message session, or other image stored on a memory of mobile device 500 or removable media (not shown in FIG. 5).

The user interface can include, for example, one or more windows, dialog boxes, images, icons, buttons or other elements. The image edit region 520 can be a user interface component, such as a window configured to allocate a portion of the screen 510 for display and editing of an image file.

The draw button 530 can be any user interface component configured to cause the image-editing module to enable drawing functionality within the image edit region 520 when pressed or selected by, for example, a finger (such as the user finger UF shown in FIG. 5). For example, a user press or selection of an area of the screen 510 that defines the draw button 530 can cause the image-editing module to activate touchscreen sensitivity on the screen 510 within the image edit region 520. When such sensitivity is activated, upon contact of a user finger UF with screen 510 within image edit region 520, the image-editing module can cause corresponding coloration to appear in the pixels aligned underneath the contacted portions of the screen 510.

The erase button 540 can be any user interface component configured to cause the image-editing module to enable erasure functionality on the screen 510 when pressed or selected by, for example, a finger (such as the user finger UF shown in FIG. 5). For example, a user press or selection of an area of the screen 510 that defines the erase button 540 can cause the image-editing module to activate touchscreen sensitivity on the screen 510 within the image edit region 520. When such sensitivity is activated, upon contact of the user finger UF with the screen 510 within the image edit region 520, the image-editing module can update coloration in the pixels aligned underneath the contacted portions of the screen 510 with a default color (such as white). In some embodiments, the described erasure functionality can only “erase” user-added coloration, such as coloration added “on top of” an existing image in response to a user's fingerstrokes and/or swipes. In such embodiments, erasure can result in the corresponding pixels displaying their original values as specified by the original image file initially loaded by the image-editing module.

The send button 550 can be any user interface component configured to, when pressed, cause the image-editing module to: 1) send the current contents of the image edit region 520 to a data-processing module (such as the data-processing module discussed in connection with FIG. 3 above) for definition of a new image file and generation of a new image instant message based on the new image file, 2) close the image-editing module and 3) cause a main instant message session window (such as the message window discussed in connection with FIG. 4 above) to be displayed to the screen 510. In some embodiments, the send button 550 can be configured to, when pressed, cause the image-editing module to 1) send image edit information to the data-processing module, 2) close the image-editing module and 3) cause the main instant message session window to be displayed to the screen 510. In such embodiments, the data-processing module can next convert the image edit information into a series of one or more directives configured to cause a device to render an edited version of the image according to the image edits described thereby.

In some embodiments, the above editing and doodling functionality can be provided by a first image-editing module in collaboration with a second image-editing module. The first image-editing module can be currently operating on a first mobile device and the second image-editing module can be currently operating on a second mobile device. The collaborative session can take place as part of an instant message session between the two devices. In this manner, each image-editing module can be configured to provide real-time, collaborative image-editing between two or more users of two or more mobile devices. In such embodiments, the image-editing module can be included in a second instant message session window positioned beside or on top of a main message window.

For example, in some embodiments, the image-editing module can send one or more signals (e.g., directives) via the mobile device to a second mobile device, the signals indicating each image edit operation as it is made or entered by the user. In such embodiments, a second image-editing module of a second, recipient mobile device can receive the signals and execute the image edit operations within that device's currently-operating instance of the image-editing module. In this manner, the second user can “watch” as the first user makes successive edits to the image. In some embodiments, users of two or more mobile devices can each enter edit commands to their respective, currently-operating instance of the image-editing module, with each such instance forwarding signals including information associated with those edits to each other mobile device connected to the interactive image-editing session. In some embodiments, each of the signals indicating each image edit operation can be included in an XML and/or XMPP tag and/or include information encoded in base64 format. In such embodiments, each of the XML and/or XMPP tags can include directive information, such as a <payload> tag. In some embodiments, each of the signals indicating each image edit operation can include identifier information associated with the sending device and/or individual currently operating the sending device.

In some embodiments, a first user of an instant messaging application can invite a second instant messaging application user to begin collaborative image-editing. In some embodiments, the first user can instruct the instant messaging application to send the invite by accessing a user interface component such as a button, checkbox, etc.

More details related to collaborative doodling and/or image-editing between mobile devices are set forth in co-pending U.S. patent application Ser. Nos. 12/480,404, 12/480,413, 12/480,422, and 12/480,435, each filed on Jun. 8, 2009, and each entitled “Methods and Apparatus for Distributing, Storing and Replaying Directives within a Network”; U.S. patent application Ser. No. 12/480,437, filed on Jun. 8, 2009, entitled “Methods and Apparatus for Selecting and/or Displaying Images of Perspective Views of an Object at a Communication Device”; U.S. patent application Ser. No. 12/480,432, filed on Jun. 8, 2009, entitled “Methods and Apparatus for Processing Related Images of an Object Based on Directives”; and U.S. patent application Ser. Nos. 12/480,416 and 12/480,421, each filed on Jun. 8, 2009, each entitled “Methods and Apparatus for Remote Interaction Using a Partitioned Display”, all of which are hereby incorporated by reference in their entireties.

The edited image element 560 can be any graphical representation of a user selection or finger swipe(s) made over a portion of the screen 510 by, for example, the user finger UF. In some embodiments, the edited image element 560 can include one or more pixels corresponding to a touched area of the screen 510 colored so as to denote having been touched by a user. In some embodiments, a user can create multiple edited image elements or “doodles” within the image edit region 520 by successive touching and swiping of the user finger UF overtop a desired portion of the screen 510. As discussed above, upon completion of editing, a user can contact and/or depress an area of the screen 510 associated with the image send button 550, thereby instructing the image-editing module to send relevant image edit region information to a data-processing module, close the image-editing module and display a user messaging window.

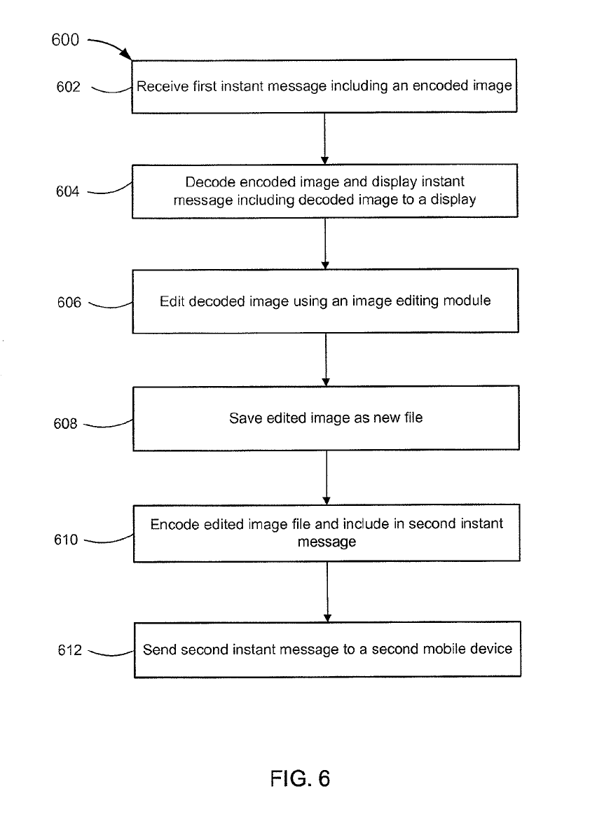

FIG. 6 is a flowchart of a method of receiving, at a mobile device, a first instant message that includes an image, editing the image, and sending a second instant message including the edited image, according to another embodiment. As shown in FIG. 6, a mobile communication device that includes an instant-messaging module can receive a first multimedia instant message that includes an encoded image, 602. The mobile communication device can be, for example, a cellular telephone or smartphone, a personal digital assistant (PDA), a laptop, notebook, or netbook computer, a tablet computing device, a VoIP telephone, or other device capable of mobile communication. The instant-messaging module can be, for example, a software application, such as a smartphone “app” stored in memory and operating on a processor within the mobile communication device. Alternatively, the instant-messaging module can be a combination of hardware and/or software. In some embodiments, the instant-messaging module can be capable of receiving and/or sending multimedia instant messages that include one or more of: graphic content, icon content, image content, video content, animation content, and/or audio content. In some embodiments, the received image can be encoded in a bitstring, such as a bitstring formatted in base-64 or other encoding.

The instant-messaging module can decode the encoded image and display the received multimedia instant message to a display, 604. In some embodiments, the instant-messaging module can decode the encoded image and instruct at least one hardware and/or software component of the mobile device to save the image to a new image file on the mobile device. In some embodiments, the instant-messaging module can instruct at least one hardware and/or software component of the mobile device to save the new image file to a memory included on the mobile device, to a remote storage location, or to a removable media asset such as a flash memory card.

In some embodiments, the instant-messaging module can instruct a display of the mobile device to display the decoded image within a message window of the instant-messaging module. In some embodiments, the instant-messaging module can instruct the display to display the decoded image in miniature form so as to preserve compatibility with screen-size constraints of the mobile device. In some embodiments, the instant-messaging module can instruct the display to display, within the message window, any accompanying text and/or other content also included in the received instant message.

The instant-messaging module can allow a user to edit the decoded image using an image-editing module, 606. For example, in some embodiments, the instant-messaging module can allow a user to launch an image-editing module and user interface as discussed in connection with FIG. 5 above. In some embodiments, the user can employ the image-editing module to modify the decoded image by, for example, adding text, geographic shapes, colored “doodles”, or other elements to the image. In some embodiments, the user can use the image-editing module to modify the decoded image by resizing, cropping, rotating, sharpening, blurring, or altering the color of the image.

The instant-messaging module can instruct at least one hardware and/or software component of the mobile device to save the edited image as a new file, 608. In some embodiments, the instant-messaging module can instruct the at least one component to save the edited image as a second new image file, distinct from the first image file discussed above. In some embodiments, the instant-messaging module can instruct the at least one component to save the edited image to a file at a memory included on the mobile device, at a remote storage location, or on a removable media asset such as a flash memory card. In some embodiments, the instant-messaging module can instruct the at least one component to save the edited image as a new file in response to a user command and/or user input. In some embodiments, the instant-messaging module can instruct the at least one component to save the edited image automatically, at, for example, periodic intervals, such as every one minute, every 30 seconds, etc. In such embodiments, the instant-messaging module can redirect the user to a main instant messaging window upon completion of the save operation. Alternatively, in some embodiments, the instant-messaging module can instruct the at least one component to save one or more directives based on each user modification described above. In this manner, the instant-messaging module can store (1) an original image and (2) directive information sufficient to define and/or render the edited version of the image using the directive information.

The instant-messaging module can encode the edited image file and include it in a second instant message, 610. In some embodiments, the instant-messaging module can include additional text and/or other content input by a user of the mobile device in the second instant message. Alternatively, the instant-messaging module can send the set of one or more directives described above.

The instant-messaging module can instruct hardware and/or software of the mobile device to send the second instant message to a second mobile device, 612. In some embodiments, the instant-messaging module can display to a user of the mobile device a delivery indicator indicating progress of the second instant message transmission. The indicator can, for example, notify the user when the second instant message has been successfully delivered to the second mobile device. The notification can optionally be in the form of a graphic, sound, pop-up or other alert.

Although not shown in FIG. 6, it should be understood that a similar method can be performed at the second mobile device. Similarly, a server receiving and formatting multimedia instant messages (such as the server device 130 described in connection with FIG. 1) can be within the flow of the messages of FIG. 6. Such a server can record and replay a recorded instant message session having multimedia instant messages. In some embodiments, the server can be configured to receive one or more requests from one or more mobile devices seeking to join the instant message session either while in-progress and/or after completion. In such embodiments, the server can accordingly play back, to a requesting mobile device, the instant message session in whole or in part (as appropriate).

In some embodiments, the server can be configured to receive, from the instant-messaging module, an undo and/or a redo command. Upon receipt of an undo command, the server can optionally send, to the instant-messaging module (and/or the second mobile device) either an updated version of the image (according to its pre-edited state) or one or more directives that when applied to the current, edited version of the image, result in rendering, display and/or storage of the image as constituted before the edits described in connection with step 606 above. In some embodiments, the server can next receive, from the instant-message module and/or the second mobile device, a “redo” command. In response to the redo command, the server can perform steps configured to reverse the effect of those described in connection with the undo command above. Said differently, the server can send, to the instant-message module and/or the second mobile device, an as-edited version of the image and/or one or more directives that when applied to the image result in rendering, display and/or storage of the image as constituted after the edits described in connection with step 606 above.

As used in this specification, the singular forms “a,” “an” and “the” include plural referents unless the context clearly dictates otherwise. Thus, for example, the term “a module” is intended to mean a single module or a combination of modules.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Some embodiments described herein relate to a computer storage product with a computer- or processor-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as general purpose microprocessors, microcontrollers, Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

What is claimed is:

1. A non-transitory processor-readable medium storing code representing instructions that when executed cause a processor to:
receive a first signal at a mobile device, the first signal including a mobile instant message having inline image data, the inline image data defining an image;
receive an edit command associated with the image; and
send a second signal, the second signal including a mobile instant message having a directive based at least in part on the edit command.

2. The non-transitory processor-readable medium of claim 1, wherein the directive is configured to instruct a recipient device to render an updated image based at least in part on the inline image data and the edit command.

3. The non-transitory processor-readable medium of claim 1, wherein the first mobile instant message is defined in an Extensible Messaging and Presence Protocol (XMPP) format, and the inline image data is defined in base64 format.

4. The non-transitory processor-readable medium of claim 1, wherein the directive includes edit information associated with at least one pixel, the edit information including at least one of:
coordinate information;
color information;
luminance information; or
blending information.

5. The non-transitory processor-readable medium of claim 1, further comprising code configured to cause the processor to:
send a third signal, the third signal including a command to store at least one of:
the first mobile instant message; and
the directive.

6. The non-transitory processor-readable medium of claim 1, further comprising code configured to cause the processor of the mobile device to:
send a third signal, the third signal configured to cause a display of the mobile device to render an updated image, the updated image being defined based at least in part on: (1) the inline image data and (2) the directive; and
send, in response to an undo command, a fourth signal, the fourth signal configured to cause the display of the mobile device to render the image in place of the updated image.

7. The non-transitory processor-readable medium of claim 1, further comprising code configured to cause the processor of the mobile device to:
send a third signal, the third signal configured to cause a display of the mobile device to render an updated image, the updated image being defined based at least in part on: (1) the inline image data and (2) the directive;
send, in response to an undo command, a fourth signal, the fourth signal configured to cause the display of the mobile device to render the image in place of the updated image; and
send, in response to a redo command, a fifth signal, the fifth signal configured to cause the display of the mobile device to render the updated image in place of the image.

8. A non-transitory processor-readable medium storing code representing instructions that when executed cause a processor to:
receive a first signal, the first signal including a mobile instant message having inline image data, the inline image data defining an image;
receive a second signal, the second signal including a mobile instant message having at least one directive associated with the image; and
send a third signal, the third signal including a command to store:
the inline image data;
a first identifier associated with a sender of the first signal; and
the at least one directive.

9. The non-transitory processor-readable medium of claim 8, further comprising code representing instructions configured to cause the processor to:
send, to a first recipient indicated by the mobile instant message of the first signal, a third signal including the mobile instant message of the first signal; and
send, to a second recipient indicated by the mobile instant message of the second signal, a fourth signal including the mobile instant message of the second signal.

10. The non-transitory processor-readable medium of claim 8, wherein the at least one directive is one of:
a background image directive; or
a line directive.

11. The non-transitory processor-readable medium of claim 8, wherein the first signal is received from a first mobile device and the second signal is received from a second mobile device.

12. The non-transitory processor-readable medium of claim 8, wherein the mobile instant message of the first signal includes a first payload tag and the mobile instant message of the second signal includes a second payload tag.

13. The non-transitory processor-readable medium of claim 8, wherein each of the mobile instant message of the first signal and the mobile instant message of the second signal is associated with a mobile instant message session, the non-transitory processor-readable medium further comprising code representing instructions configured to cause the processor to:
receive a third signal, the third signal including a request to play back the instant message session;
send, in response to the request, a fourth signal having the mobile instant message of the first signal; and
send, in response to the request, a fifth signal having the mobile instant message of the second signal.

14. A non-transitory processor-readable medium storing instructions configured to cause a processor to:
receive a first signal at a mobile device, the first signal including a mobile instant message having a directive, the directive being defined based at least in part on an image stored at the mobile device; and
send, to a display of the mobile device, a second signal having updated image data, the updated image data based at least in part on an image and the directive.

15. The non-transitory processor-readable medium of claim 14, wherein the directive is a first directive and the updated image data defines an updated image, the non-transitory processor-readable medium further comprising code to cause the processor to:
receive a user input signal at the mobile device, the user input signal indicating one or more edits to the updated image,
define, at the mobile device, based on the user input signal, a second directive indicating one or more changes to one or more pixels included in the updated image; and
send, from the mobile device, a fourth signal including the updated image data and the second directive.

16. The non-transitory processor-readable medium of claim 14, wherein the directive is defined based at least in part on a user input signal, the user input signal being at least one of:
a key press, the processor to configured to add a character to the image in response to the key press;
a touchscreen swipe, the processor configured to add a line to the image in response to the touchscreen swipe; or
a touchscreen pinch, the processor configured to shrink an element of the image in response to the touchscreen pinch.

17. The non-transitory processor-readable medium of claim 14, wherein the first signal is associated with a mobile instant message session, the non-transitory processor readable medium further comprising code configured to cause the processor to:
send, from the mobile device, a third signal including a request to join the mobile instant message session, the mobile instant message session being associated with a second mobile device and a third mobile device, the third signal being sent at a first time before (1) the receiving of the first signal and (2) the sending of the second signal.

18. The non-transitory processor-readable medium of claim 14, wherein the directive of the first signal is included in an Extensible Markup Language (XML) payload tag.

19. The non-transitory processor-readable medium of claim 14, wherein the updated image data is based at least in part on a Portable Network Graphics (PNG) data object, the PNG data object defined based at least in part on a received image file, the received image file being one of:
a Graphics Interchange Format (GIF) image file;
a Joint Photographic Experts Group (JPEG) image file;
a Tagged Image File Format (TIFF) image file;
a Windows bitmap image file; or
a RAW image file.
